(19) United States
(12) Patent Application Publication
(10) Pub. No.: US 2005/0213756 A1
(43) Pub. Date: Sep. 29, 2005

(54) Round key generation for aes rijndael block cipher

(75) Inventor: Gerardus T. M. Hubert, Geldrop (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: Koninklijke Philips Electronics N.V.

(21) Appl. No.: 10/519,586

(22) PCT Filed: Jun. 12, 2003
(86) PCT No.: PCT/IB03/02623

§ 371 Date: Dec. 22, 2004

(30) Foreign Application Priority Data
Jun. 25, 2002 (GB) 0214620.7

(51) Int. Cl. H04L 9/00

(52) U.S. Cl. 380/44

(57) ABSTRACT

Successive round keys of an expanded key according to the AES block cipher algorithm are generated from an initial cryptographic key, for use in a cryptographic (encryption and/or decryption) engine, in real time as the cryptographic process is executing. A limited key memory is used by overwriting previously generated words of the expanded key, leaving only the words of the initial key and the final key in the memory. Thus, a subsequent cryptographic operation can recommence either in the encryption or decryption direction, without delay to the cryptographic engine.

The present invention relates to methods and apparatus for implementation of the Advanced Encryption Standard (AES) algorithm and in particular to methods and apparatus for real-time generation of the round keys required during the encryption and decryption rounds of the algorithm.

The invention has particular, though not exclusive, application in cryptographic devices such as those installed in smart cards and other devices where processor and memory resources are limited.

The AES (Rijndael) algorithm may be implemented using a 128-bit, a 192-bit or a 256-bit key operating on successive 128-bit blocks of input data. During implementation of an encryption operation or a decryption operation according to the AES algorithm (hereinafter, generally a “cryptographic operation”), the original or “initial” key must be expanded to provide a round key for each successive round of the encryption or decryption operation. The number of rounds (Nr) is 10 for 128-bit keys, 12 for 192-bit keys, and 14 for 256-bit keys.

Thus, the expanded round key is the size of the initial key multiplied by (Nr+1). In the case of a 128-bit key, the expanded key comprises 128×11=1408 bits; for the 192-bit key, the expanded key comprises 128×13=1664 bits; and for the 256-bit key, the expanded key comprises 128×15=1920 bits.

Storage of this expanded key consumes a significant amount of memory space in cryptographic engines, which is particularly significant in certain applications, such as the provision of cryptographic engines on smartcards and the like where memory space is limited. Provision of this space is not strictly necessary if round keys can be generated during operation of the cryptographic engine without causing delay thereto.

The present invention is directed towards a key expansion method and apparatus to implement the round key generation function in real time using a substantially reduced memory allocation than existing techniques.

The present invention recognises that real time generation of the successive round keys can be performed in parallel with execution of the encryption or decryption algorithm in the cryptographic engine and have little impact on the execution time of the encryption or decryption process and with reduced amounts of hardware.

According to one aspect, the present invention provides a method of generating successive round keys of an expanded key from an initial cryptographic key for use in an encryption and/or decryption engine, comprising the steps of:
storing the Nk words of the initial key in Nk locations of a memory;
providing the initial key to a cryptographic engine for performing a first cryptographic round;
repeatedly retrieving a selected first word and a selected second word of the expanded key, at least one of which is retrieved from the memory, and generating from the selected first and second words a successive subsequent word of the expanded key;
providing the generated words of the expanded key to the cryptographic engine as round keys for performing subsequent cryptographic rounds; and
storing successive ones of the generated subsequent words in the memory by cyclically overwriting previously generated words of the expanded key.

According to another aspect, the present invention provides a round key generator for generating successive round keys of an expanded key from an initial cryptographic key for use in an encryption and/or decryption engine, comprising:
a memory for storing the Nk words of the initial key;
an expansion processor for repeatedly retrieving a selected first word and a selected second word of the expanded key, at least one of which is retrieved from the memory, and generating from the selected first and second words a successive subsequent word of the expanded key;
means for providing the generated words of the expanded key to the cryptographic engine as round keys for performing subsequent cryptographic rounds; and
means for storing successive ones of the generated subsequent words in the memory by cyclically overwriting previously generated words of the expanded key.

According to another aspect, the present invention provides an AES round constant function generator comprising a shift register having:
a first control input for causing a left shift of the register contents;
a second control input for causing a right shift of the register contents; and
a third control input for causing a preset of the shift register contents to one of several possible values.

Embodiments of the present invention will now be described by way of example and with reference to the accompanying drawings in which:

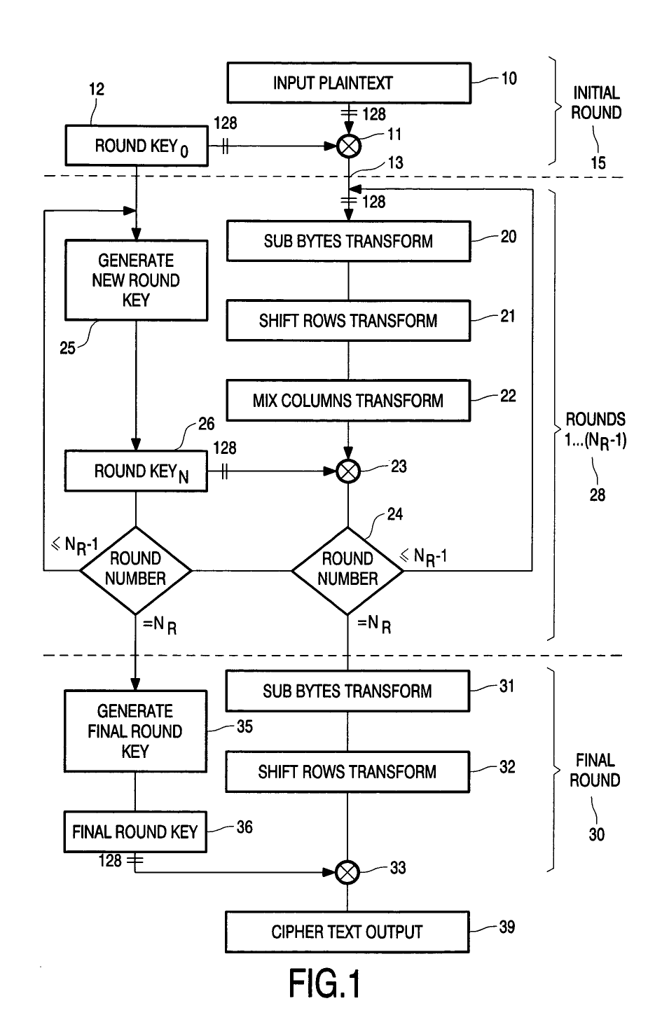

FIG. 1 is a flow diagram illustrating implementation of an encryption operation using the AES block cipher algorithm;

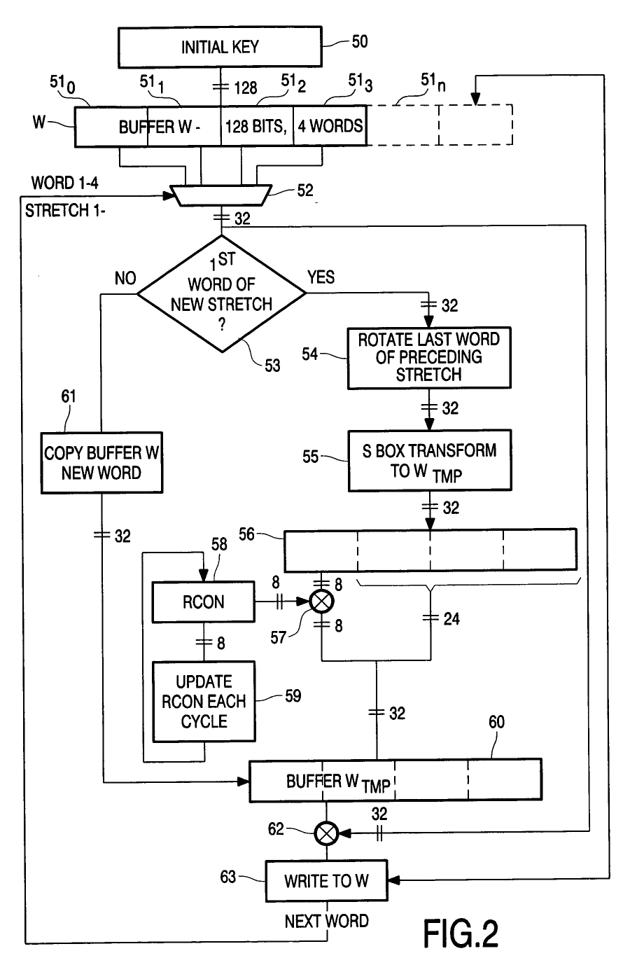

FIG. 2 is a flow chart of the AES round key schedule used to generate the expanded encryption key that provides the plural round keys required during an encryption operation;

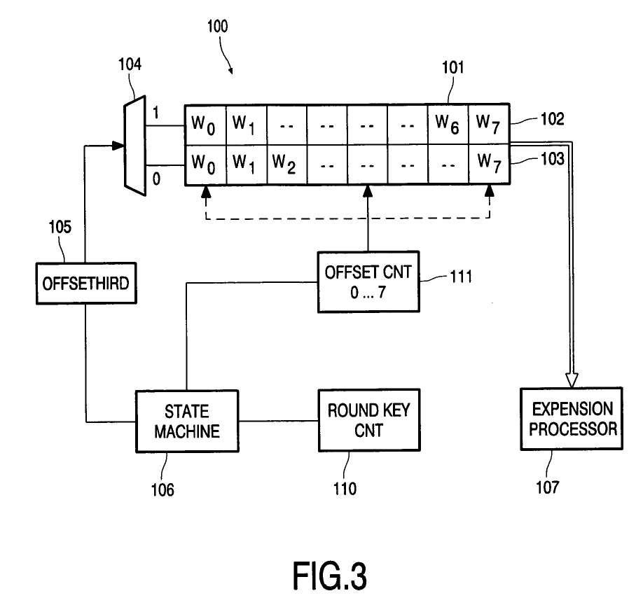

FIG. 3 is a schematic block diagram of a round key generator according to the present invention;

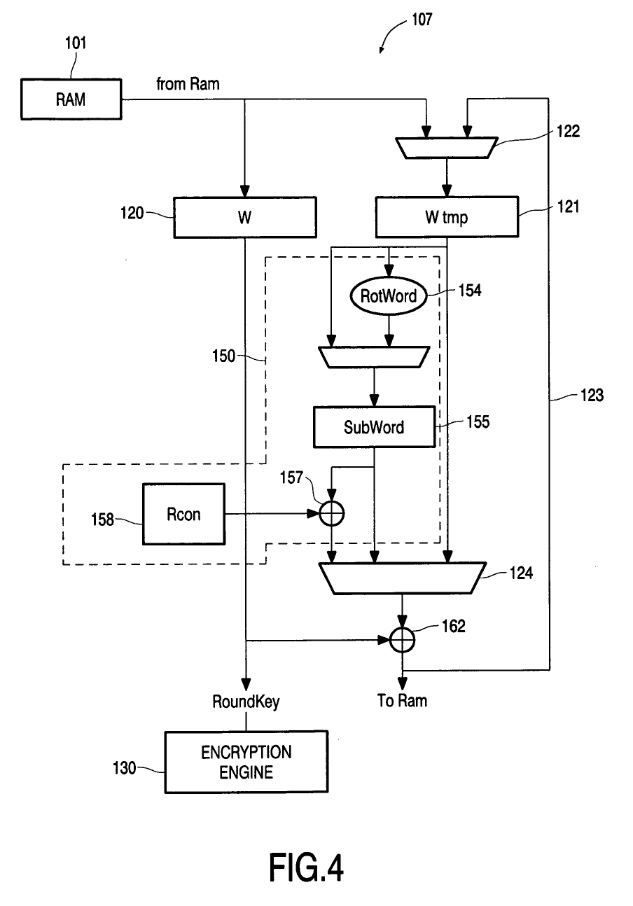

FIG. 4 is a schematic block diagram of the key expansion processor for generating the succession of round keys during encryption; and

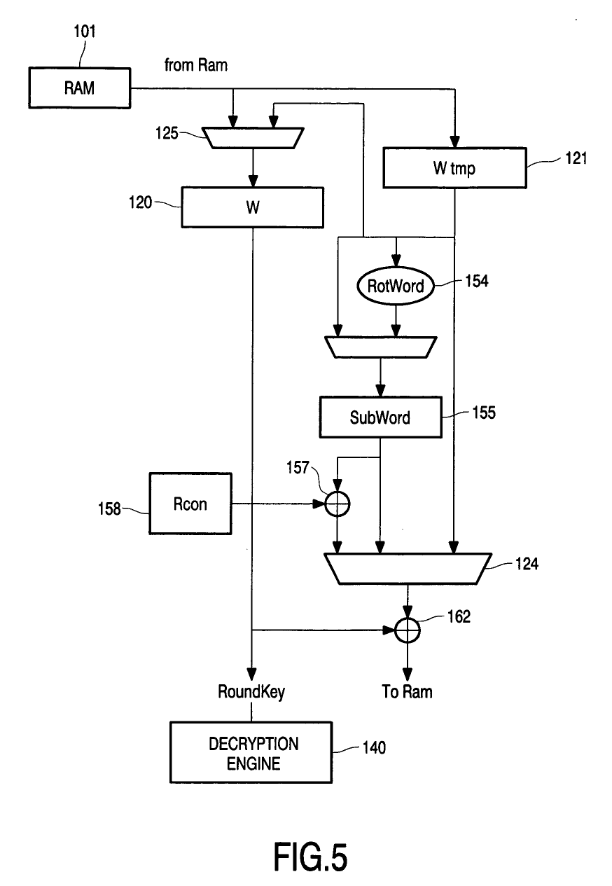

FIG. 5 is a schematic block diagram of the key expansion processor for generating the succession of round keys during decryption.

The AES algorithm for encryption of plaintext to ciphertext is shown in FIG. 1. The AES algorithm may be implemented using a 128-bit, a 192-bit or a 256-bit key operating on successive 128-bit blocks of input data. FIG. 1 will now be described in the context of the basic implementation using a 128-bit key.

An initial 128-bit block of input plaintext 10 is XOR-combined 11 with an original 128-bit key 12 in an initial round 15. The output 13 from this initial round 15 is then passed through a number of repeated transform stages, in an encryption round 28 which includes the SubBytes transform 20, the ShiftRows transform 21 and the MixColumns transform 22 in accordance with the defined AES algorithm.

The output from the MixColumns transform 22 is XOR-combined 23 with a new 128-bit round key 26, which has been derived from the initial key 12. The output from this XOR-combination is fed back to pass through the encryption round 28 a number of further times.

For each successive iteration through the encryption round 28, a new round key 26 [symbol] is derived from the existing round key 26 according to the AES round key schedule.

The number of iterations (Nr−1) of the encryption round 28 is 9 where a 128-bit encryption key is being used, 11 where a 192-bit encryption key is being used, and 13 where a 256-bit encryption key is being used.

After the requisite number (Nr−1) of rounds 28, a final round, Nr, is entered under the control of decision box 24. The final round 30 comprises a further SubBytes transform 31, a further ShiftRows transform 32, and a subsequent XOR-combination 33 of the result with a final round key 36 generated 35 from the previous round key. The output therefrom comprises the ciphertext output 39 of the encryption algorithm.

It will be noted from FIG. 1 that the implementation of the AES encryption algorithm requires generation of new round keys from the initial key 12 ready for each round 28, 30.

Throughout the present specification, the keys will be expression in terms of the number, Nk, of 32-bit words. For an initial 128-bit encryption key 12, ie. 4×32-bit words, Nk=4, and the “expanded” key comprises 11×4 32-bit words, or 44 words, written as W(0) . . . W(43). For an initial 192-bit encryption key (Nk=6), the expanded key rises to 13×4 32-bit words, or 52 words, written as W(0) . . . W(52). For an initial 256-bit encryption key (Nk=8), the expanded key rises to 15×4 32-bit words, or 60 words, written as W(0) . . . W(59).

During execution of the AES decryption algorithm, the round keys are the same as for encryption, but presented in the reverse order.

With reference to FIG. 2, the general AES key expansion algorithm for generating the successive round keys will now be described, in the context of a 128-bit key (number of words in the key, Nk=4). It will be understood that the technique also applies to 192-bit (Nk=6) and 256-bit (Nk=8) keys.

The initial key 50, comprising four 32-bit words W(0), W(1), W(2) and W(3) is loaded into suitable memory locations 51₀, 51₁, 51₂, 51₃. In a conventional implementation, the memory includes sufficient space, at 51ₙ to accommodate all words of the expanded key, once it is generated.

Each new sequence of four words in the expanded key comprises a new round key and will be referred to as a “stretch”. More generally, a stretch is W(i) to W(i+Nk) where i is an integer multiple of Nk, minus 1 (0, 3, 7 etc for Nk=4; 0, 7, 15 for Nk=8). At the outset, the only stretch is the initial key 50, and the first task is to generate the first word of a new stretch, the decision box 53 thereby indicating path “yes”.

In the initial pass of the key expansion algorithm, the last word of the preceding stretch (51₃) is extracted (at 52) and the bits left shifted (step 54), transformed according to the AES key expansion algorithm using an S-box look-up 55. The S-box function is the same as that for the AES SubBytes transform 20 (FIG. 1). The resulting 32-bit output 56 is transformed by XOR-combination 57 of the first eight bits only with a round constant Rcon 58 defined in the AES key schedule. The output 60 from this operation is then XOR-combined 62 with the first word of the preceding stretch (ie. 51₀) and this result—W(4)—written to memory at 51₄.

In the second pass through the flow diagram, the next word W(5) of the second stretch is derived. This being the second word of a stretch, the left hand path of the flow diagram is taken, the newly generated word, W(4), at 51₄, being copied directly to the Wtmp buffer 60 ready for simple XOR-combination 62 with the next word 51₁ of the initial key 50. The new generated word W(5) is written (at 63) to memory 51₅.

The procedure repeats the left hand path a further two times, generating the last two words W(6) and W(7) of the second stretch, before recommencing the cycle for the third stretch, using the right hand path.

In effect, it will be seen that each word of each new stretch is the XOR-combination of its immediately preceding word and the word in the corresponding position of the preceding stretch, with the exception of the first word in each stretch. For the first word in each stretch, it is a function of the immediately preceding word that is used, rather than the immediately preceding word itself, the function being executed according to steps 54-59 of FIG. 2.

The principle deployed for 192-bit (Nk=6) and 256-bit (Nk=8) keys is the same, except that each stretch is respectively six words or eight words in length.

Each successive group of four words is used as the round key for each successive round 28, 30 of the encryption procedure of FIG. 1. During decryption, the round keys are applied in reverse order.

In one aspect, the present invention recognises that it is only necessary to retain in memory the Nk words of the original key together with the most recent Nk words of the expanded round key at any one time. The most recently generated four words (or, more generally, four successive words in the currently held Nk words) are fed into the encryption engine at steps 23 or 33, while the held Nk words are used to generate the new stretch as described in FIG. 2.

Providing that the new stretches are generated fast enough to keep up with the encryption engine, and maintained in synchronism therewith (within the tolerance of the difference of a stretch length (Nk=4, 6 or 8) and round key length (=4) so that the most recently generated stretch includes the round key which is currently required in the encryption engine, then very limited memory capacity and buffer requirements only need be provided.

With reference to FIG. 3, the round key generator 100 comprises a RAM sector 101 that is divided into equal parts 102, 103, each part having a size of, for example, 4×32 bit words (for the 128-bit key algorithm), 6×32 bit words (for the 192 bit key generator) or 8×32 bit words (for the 256 bit key algorithm). Throughout the following description, a round key generator 100 capable of handling a 256-bit key algorithm will be assumed, this being adaptable to accommodate processing of smaller key lengths.

For convenience, the two parts 102, 103 will be referred to as the lower half 103 and the upper half 102. The respective halves are referenced for read access by an OffSetHiRd pointer 105 via mux 104. For OffSetHiRd=0, lower half 103 is read; for OffSetHiRd=1, upper half 102 is read. In the lower half 103 of the RAM 101, the initial encryption key 50 is stored in locations W₀ to W₇ (ie. the first stretch W(0) . . . W(7) for Nk=8); in the upper half 102, the new calculated stretch, eg. W(8) . . . W(15) is stored in corresponding upper half locations W₀ . . . W₇. A pointer OffSetHiWr (not shown) may be used to point to the memory half being written to). As each successive stretch is generated and used in the encryption engine, the next stretch values (eg. W(16) . . . W(23)) are calculated and overwritten into the upper half 102.

The individual locations W₀ . . . W₇ (lower half) or W₁ . . . W₇ (upper half) are referenced for read and write operations by an OffSetCnt counter 111 which is a three-bit counter that points to one of the word locations in the upper half and/or the corresponding location in the lower half. In general, the OffSetCnt counter 111 is implemented as a modulo Nk up/down counter.

A round key counter 110 maintains a count of the currently calculated round key (ie. the current stretch). A state machine 106 maintains overall control of the round key generation process, and an expansion processor 107 performs the computation of the expanded round key values (words).

When the encryption operation for the current plaintext block is complete, the procedure may be recommenced from the encryption key in the lower half 103. Alternatively, if a decryption operation is required, the first round key of the decryption cycle comprises the most recently calculated round key from the upper RAM half 102, which may be moved into the lower half, or read from the upper half. Successive decryption round keys are calculated in similar manner. At the completion of the decryption round key generation operation, the original encryption key is returned and can be restored to or retained in the lower half of RAM 101 for a subsequent encryption operation.

FIG. 4 shows a block diagram of the expansion processor 107. The expansion processor 107 comprises a first 32-bit register W, shown at 120, and a second 32-bit register Wtmp, shown at 121. Each register W, Wtmp can be filled directly from the RAM 101. A 32-bit, two input multiplexer 122 also allows the filling of Wtmp via a feedback line 123. The expansion processor 107 further includes special processing logic 150 for effecting the transforms RotateWord 154, SubWord 155, Rcon 158 as described in connection with transforms 54, 55, 58 in FIG. 2. A 32-bit multiplexer 124 selects output from either the special processing logic 150 or direct from register Wtmp 121 to provide input to 32-bit wide XOR gate 162.

At the start of an encryption operation, the initial key 50 (W(0) . . . W(7)) is loaded into RAM 101 into the lower half 103, positions W₀ . . . W₇. The first word W(0) of the initial key 50 is loaded into the buffer 120 from RAM 101 and the last word W(Nk−1) of the initial key 50 is loaded into buffer Wtmp 121. More generally, for successive rounds of encryption, W(i) is loaded into buffer 120, and the last calculated value of W(i+Nk) is stored in Wtmp 121.

As defined with reference to FIG. 2, during a key expansion process for encryption, one the following equations applies to the generation of each new word W(i) of the expanded round key:
For all i except those below (ie. no special processing 150),
Rule 1: W(i)=W(i−Nk)⊕(W(i−1)
When i mod Nk=0 (the beginning of each stretch),
Rule 2: W(i)=W(i−Nk)⊕SubWord (RotWord(W(i−1)))⊕Rcon(i/Nk)
When i mod Nk=4 and Nk=8 (the middle cycle of each 8 word stretch),
Rule 3: W(i)=W(i−Nk)⊕SubWord(W(i−1))
   where:
   RotWord(Wtmp) is a bytewise rotation of Wtmp,
   SubWord is the AES S-box transform,
   Rcon is the round constant as defined in the AES standard, which is applied only to the first byte of the first word in each stretch, while the other bytes are passed unchanged,
   i=0 . . . 4Nr+3,
   ie.
      i=0 . . . 43for Nk=4;
      i=0 . . . 51 for Nk=6 and
      i=0 . . . 59 for Nk=8.

In other words, for the first word of each new stretch, the special processing of steps 54-59 is applied and W(Nk) is calculated as the XOR-combination 62 of W(0) from register 120 and the transformed W(Nk−1). For the middle word of each stretch when Nk=8, the special processing only of step 55 is applied. For other words in each stretch, the contents of register 120 and register 121 are XOR-combined directly without the special processing of steps 54 to 59.

With reference to FIG. 4, register W is loaded with W(0) and register Wtmp is loaded with W(Nk−1) [e.g. W(7) for Nk=8]. Then the result of the calculation, being W(Nk), [e.g. W(8)], is output from XOR gate 162 and stored in both RAM 101 [eg. at location W₀, upper half] and in register Wtmp 121. Then, register W is loaded with W(1), while register Wtmp holds W(Nk), [e.g. W(8)]. Then W(Nk+1) [eg. W(9)] is calculated and stored in RAM 101 [at location W₁, upper half] and in register Wtmp.

In general, register W is loaded from RAM 101 with W(i), while register Wtmp holds the value of W(i+Nk−1). Then W(i+Nk) is calculated and stored both in RAM 101, at position W_{(i+Nk) mod 8}, upper half (ie. new values are stored cyclically in the upper half 102), and in Wtmp.

The key expansion process runs in parallel with the encryption processor 130 which preferably works word-by-word rather than on blocks 128 bits wide. In this manner, the content of W can be passed directly to the encryption processor to be used immediately as input for the encryption process. In the alternative, the encryption processor 130 may be coupled directly to access RAM 101 to retrieve the required words of the round key. This configuration allows more flexibility in the relative timing of the cycles of operation of the encryption engine 130 and the expansion processor 107.
For each cycle of operation, the new value of Wtmp is such that:
Wtmp=Wtmp⊕W, except for the following cases:
When i mod Nk=0,
then Wtmp=SubWord(RotWord(Wtmp))⊕Rcon(i/Nk)⊕W
When i mod Nk=4 and Nk=8,
then Wtmp=SubWord(Wtmp)⊕W

During the key expansion process, the pointer OffSetHiRd 105 effectively points to a base word location in RAM 101 either in the upper half 102 and the lower half 103. Control of the read locations is implemented by this one-bit pointer which respectively selects the read half of the memory. Thus, during the first cycle of key expansion (during computation of the second stretch), the initial key words W(0) . . . W(7) are read from the lower half 102, ie. the read flag 105 selects OffSetLo. During encryption key expansion, new values of the round keys are always written to the upper half 102.
At the start, the following initialisation settings apply:
OffSetCnt=0, OffSetHiRd=0, OffSetHiWr=1, RndCnt=4Nr+3.
The RAM 101 is read at address W_{Nk-1}, determined by OffSetHiRd and OffSetCnt (i.e. OffSetCnt+Nk−1), and stored in Wtmp.
   Then the following procedure is executed Nk times:
1. Read the RAM at W_{OffSetCnt} from the lower half, and store it in W.
2. Generate the next expanded key word and write it to Wtmp and to the memory at W_{OffSetCnt} in the upper half 102.
3. Increment OffSetCnt and decrement RndCnt.
4. Update Rcon only after the first cycle of the Nk cycles.

All words of the initial key from the lower half 103 have now been used. OffSetHiRd is set to 1, so that all subsequent round key words are read from the upper half 102. For example, for Nk=8, the memory at address W₈ contains W(8).

Now, the following procedure is executed repeatedly until RndCnt=Nk−1.
1. Read RAM at OffSetCnt from the upper half (OffSetHi=1) and store it in W.
2. Generate the next Round Key word and write it to Wtmp and to the RAM at OffSetCnt in the upper half.
3. Update Rcon when OffSetCnt=0
4. Increment OffSetCnt and decrement RndCnt.
For Nk=4, the last calculation is W(43)=W(39)⊕W(42). OffSetCnt=43 mod4=3.
For Nk=6, the last calculation is W(51)=W(45)⊕W(50). OffSetCnt=51 mod 6=3.
For Nk=8, the last calculation is W(59)=W(51)⊕W(58). OffSetCnt=59 mod 8=3.

So, independent of Nk, the last Round Key word is always stored at OffSetCnt=3.

At this point, the last Nk round key words are used by the encryption processor 130, but there are no more Round Key words to be generated by the expansion processor. Thus, the following procedure is executed repeatedly until RndCnt=0:
1. Read the RAM at W_{OffSetCnt} from the upper half and store it in W.
2. Increment OffSetCnt and decrement RndCnt.

It will be noted that the lower half 103 of the RAM 101 now contains the initial encryption key (Nk words), and the upper half 102 of RAM now contains the final Nk words of the expanded key. The final Nk words of the expanded key are the first Nk words of the decryption key.

Thus, the RAM now contains the initial round key for encryption and the initial round key for decryption. Therefore, it does not matter whether the next operation to be performed by the cryptographic engine is an encryption operation or a decryption operation—the expansion processor can commence key expansion starting from either the upper half 102 or lower half 101.

During decryption, the Encryption Round Keys are applied in reverse order.

Therefore, in operation of the present invention, during decryption it is necessary to generate W(i) from W(i+Nk) and W(i+Nk−1).

The inverse of the key expansion process requires that:

Rule 1: W(i−Nk)=W(i)⊕W(i−1)
for all i, except:
Rule 2: W(i−Nk)=W(i)⊕SubWord (RotWord (W(i−1)))⊕Rcon(i/Nk)
when i mod Nk=0, and
Rule 3: W(i−Nk)=W(i)⊕SubWord(W(i−1))
when i mod Nk=4 and Nk=8.
Note, that all W(i−Nk) and W(i) have interchanged places, but the complex second input is the same as for encryption.

Taking Nk=4 as an example, the last W that was generated during encryption was W(43). During decryption key expansion, the first time W is loaded, it is loaded from RAM 101; thereafter subsequent W may be obtained from Wtmp.

Thus, the first step is to load W with W(43) (found in the upper RAM half 102 at W₁₁, OffSetCnt 3) and Wtmp with W(42) (found in the upper RAM half 102 at W₁₀, OffSetCnt 2). Then, we calculate W(39)=W(43)⊕W(42) and write the result to RAM 101 in the lower half 103 at W₃. The content of Wtmp is then shifted to W, which then holds W(42) and Wtmp is loaded with W(41).

In the next cycle, we calculate W(38)=W(42)⊕W(41) and write the result to RAM 101 at W₁ and we shift the content of Wtmp to W, which then holds W(41) and we load Wtmp with W(40). This cycle is repeated for successive W.

In general, register W is loaded from RAM (or from Wtmp) with W(i) and register Wtmp is loaded from RAM with W(i−1). Then W(i−Nk) is calculated and stored in lower RAM half at position W_{i mod 8} and the content of Wtmp transferred to W.

The decryption key expansion process runs in parallel with the decryption processor which preferably works word-by-word rather than on blocks 128 bits wide, i.e. the content of W is also passed to the decryption engine 140 for use as input for the decryption operation.
At the start, the following initialisation settings apply:
OffSetCnt=3, OffSetHiRd=1, OffSetHiWr=0, RndCnt=4Nr+3.
The RAM 101 is read at address OffSetCnt [OffSetCnt=3, giving W(4Nr+3), eg W(43) for Nk=4] and stored in W.
   Then, the following procedure is executed Nk−1 times:
1. Read the RAM at W_{OffSetCnt-1 mod Nk} from the upper half and store it in Wtmp [W(42), W(41) and W(40) for Nk=4].
2. Generate the next expanded key word and write it to RAM at OffSetCnt in the lower half [W(39), W(38) and W(37) for Nk=4].
3. Transfer the content of Wtmp to W
4. Decrement OffSetCnt and decrement RndCnt.

All words from the upper half have now been used. OffSetHiRd is set to 0, so all following key words are read from the lower half. For example, for Nk=4, the memory at address 3 in the upper half contains W(39).

Now, the following procedure is executed repeatedly until RndCnt=Nk−1.

1. Read the RAM at W_{OffSetCnt-1 mod Nk} from the lower half and store it in Wtmp.
2. Generate the next Round Key word and write it to Wtmp and to the memory at OffSetCnt in the lower half.
3. Transfer the content of Wtmp to W.
4. Update Rcon when OffSetCnt=0
5. Decrement both OffSetCnt and RndCnt.
   At this point, the last Nk round key words are used by the decryption processor 140 but we do not need to generate more Round Key words. Thus, the following procedure is executed repeatedly until RndCnt=0:
1. Read the memory at W_{OffSetCnt-1 mod Nk} from the lower half and store it in Wtmp.
2. Transfer the content of Wtmp to W.
3. Decrement both OffSetCnt and RndCnt.
   Note that the very last read may be omitted, since it will not be used.

In a preferred embodiment, the SubWord function 55, 155 in the key expansion process may be implemented by the same hardware as that which implements the SubBytes transform 20, 31 of the encryption/decryption processes. In practice, it is found that this has minimal if any delaying effect on the encryption/decryption processes. Only every Nth round, will the key expansion processor compete with the encryption/decryption process for the same hardware.

Where the key expansion and cryptographic processes are in lock step on a word-by-word basis, the key expansion engine and the cryptographic engine will wait for each other before going to the next round, and every Nth round they have also to wait for separate access to the S-Box transform functions. However, while the cryptographic engine performs the ShiftRow transform 21 or the MixColumn transform 22, the key expansion processor can use the S-Box hardware.

The minimum amount of memory 101 required for efficient bi-directional operation is 2Nk words: one half (Nk) to store the encryption key and the other half to store the decryption key.

During encryption, the first Nk words are taken from the encryption (lower) half. All generated round key words are written to the decryption (upper) half. At the end of encryption, the decryption (upper) half holds the decryption key.

During decryption, the first Nk words are taken from the decryption (upper) half, which is in effect the “initial key” for decryption. All generated round key words are written to the encryption (lower) half. Although that means that the encryption key is temporarily overwritten, after decryption, the encryption key is regenerated. The decryption key is not overwritten.

Thus, after a first encryption process, the key expansion processor can immediately generate an expanded encryption key or an expanded decryption key, by selecting to start either from the lower half 103 or the upper half 102. For first time operation, with a new key, it is necessary to perform an encryption operation in order to generate the decryption key.

It is possible to reduce the amount of memory to as little as Nk words. However, this is less efficient in that if a number of consecutive encryption or decryption operations are required, each one must be interspersed with a dummy decryption or encryption operation to regenerate the initial encryption (or decryption) key. In general, this is less desirable.

State machine 106 controls the various registers and counters as follows, applicable to all cases of Nk=4, 6 or 8.

The 3-bit up/down counter OffSetCnt 111 points to the address to each half of the memory. It counts up during encryption; when it reaches Nk−1, then it is reset to 0 again. It counts down during decryption. When it is 0, it is reset to Nk−1.

When OffSetCnt=0, then Rule 2 for W(i) applies. When OffSetCnt=4 and Nk=8, then Rule 3 applies. For all other values of OffSetCnt, Rule 1 applies.

The 1-bit variable OffSetHiRd is set to point initially (for the first Nk reads) to the lower RAM half during encryption, then to the upper RAM half 102 for all subsequent reads. During decryption, OffSetHiRd is set to point initially (for the first Nk reads) to the upper RAM half then to the to the lower RAM half 103 for all subsequent reads. The 1-bit variable OffSetHiWr is set to point to the upper RAM half 102 for all writes during encryption, and to point to the lower RAM half for all writes during decryption. The 6-bit down counter RndCnt 110 counts the number of rounds.

With reference again to FIG. 2, the round constant Rcon 58 must be updated (step 59) each cycle, ie. after each use thereof.

For the first cycle, Rcon[1]=1. After each cycle, the value of Rcon is updated such that:
Rcon[i/Nk]=xtime(Rcon[i/Nk−1],
i.e. the previous value of Rcon is left-shifted, and when the most significant bit=1 then the hex value 1B is added to Rcon.

According to the AES specification, the function Rcon[i/Nk] is called when

i mod Nk=0, while Nk≦i<Nb(Nr+1).

| Nk | Nb | Nr | Nb(Nr + 1) |
|---|---|---|---|
| 4 | 4 | 10 | 44 |
| 6 | 4 | 12 | 52 |
| 8 | 4 | 14 | 60 |

For Nk=4, Rcon[i/Nk] is called for at i=4, 8, . . . 40, i.e. 10 times. The last value=36h.
For Nk=6, Rcon[i/Nk] is called for at i=6, 12, . . . 48, i.e. 8 times. The last value=80h.

For Nk=8, Rcon[i/Nk] is called for at i=8, 16, . . . 56, i.e. 7 times. The last value=40h.

| | i/Nk | | | | | | | | | |
|---|---|---|---|---|---|---|---|---|---|---|
| | 1 | 2 | 3 | 4 | 5 | 6 | 7 | 8 | 9 | 10 |
| Rcon[i/Nk] | 01 | 02 | 04 | 08 | 10 | 20 | 40 | 80 | 1B | 36 |

In a preferred embodiment, the RCon function 58, 59 is implemented as an 8-bit shift register, which can shift both left (for encryption) and right (for decryption). The shift register can be preset to the following values 01h, 1Bh, 36h, 80h and 40h.

For encryption, it is preset to 01h. It shifts to the left, except when it reaches 80h, at which point it is preset to 1Bh.

For decryption, it is preset to 36h for Nk=4, 80h for Nk=6 and 40h for Nk=8. It shifts to the right, except when it reaches 1Bh, at which point it is preset to 80h.

Thus, the shift register effectively has three control inputs. A first control input effects a left shift (bit rotation) of the register, which is used during each cycle during the encryption key expansion. A second control input effects a right shift (bit rotation) of the register, which is used during each cycle during the decryption key expansion. A third control input causes presetting of the register with one of a number of predetermined values, according to the current value of the register, and the direction (encryption or decryption).

It will be noted, in a general sense, that the present invention provides a method of generating successive round key words of an expanded key, from an initial key, which method maintains the generated successive round key words in memory substantially only as long as they are required for use in the generation of successive round key words and for use in the parallel operation of a cryptographic process.

In the preferred embodiment, the initial key words are also maintained in the memory.

Other embodiments are intentionally within the scope of the accompanying claims.

1. A method of generating successive round keys of an expanded key from an initial cryptographic key for use in an encryption and/or decryption engine, comprising the steps of:
storing the Nk words of the initial key in Nk locations of a memory;
providing the initial key to a cryptographic engine for performing a first cryptographic round;
repeatedly retrieving a selected first word and a selected second word of the expanded key, at least one of which is retrieved from the memory, and generating from the selected first and second words a successive subsequent word of the expanded key;
providing the generated words of the expanded key to the cryptographic engine as round keys for performing subsequent cryptographic rounds; and
storing successive ones of the generated subsequent words in the memory by cyclically overwriting previously generated words of the expanded key.

2. The method of claim 1 in which the step of overwriting previously generated words only occurs after those words have been used as said first and/or said second selected words in the step of generating a respective subsequent word.

3. The method of claim 1 in which the number of memory locations used is less than the number of words in the expanded key.

4. The method of claim 1 in which the number of memory locations used is equal to Nk.

5. The method of claim 4 in which the words of the initial key are also overwritten by words of the expanded key during the overwriting step.

6. The method of claim 1 in which the number of memory locations used is equal to 2Nk.

7. The method of claim 1 in which the memory is divided into two parts, a first part storing the initial key and the second part receiving the successively generated words of the expanded key.

8. The method of claim 7 further including the step of completing generation of the expanded key such that the final round key is stored in the second part of the memory and the initial key is still stored in the first part of the memory.

9. The method of claim 8 further including the step of performing a repeat key expansion starting with the initial key stored in the first part of the memory.

10. The method of claim 8 further including the step of performing an inverse key expansion starting with the final round key stored in the second part of the memory.

11. The method of claim 1 further including the step of completing generation of the expanded key such that the final round key is stored in the memory and the initial key has been overwritten.

12. The method of claim 11 further including the step of performing an inverse key expansion starting with the final round key stored in the memory in order to regenerate the initial key for a subsequent cryptographic operation.

13. The method of claim 7 in which the number of memory locations used is equal to 2Nk, the first and the second parts having Nk locations each.

14. The method of any preceding claim in which the step of generating successive subsequent words of the expanded key comprises generating successive words of the AES Rijndael block cipher round keys according to the AES key expansion function.

15. The method of claim 14 in which Nk=8.

16. The method of claim 1 in which the successive subsequent words of the expanded key comprise words of encryption round keys.

17. The method of claim 1 in which the successive subsequent words of the expanded key comprise words of decryption round keys.

18. The method of claim 1 in which the step of providing the generated words of the expanded key to the cryptographic engine comprises providing the words on a word-by-word basis as the cryptographic engine consumes the words as round keys.

19. The method of claim 1 in which, in the retrieving step, both the selected first word and the selected second word are retrieved from the memory.

20. The method of claim 1 in which, in the retrieving step, the selected first word is retrieved from memory and the selected second word is retrieved from a register used in a previous iteration.

21. The method of claim 1 in which the step of providing the generated words of the expanded key to the cryptographic engine comprises providing said generated words from the memory.

22. The method of claim 1 in which the step of generating includes, in at least some cycles of round key word generation, the step of performing an S-box transform using an S-box shared with the cryptographic engine.

23. The method of claim 22 further including the step of maintaining synchronism of the generation of successive round key words with consumption of the round key words by the cryptographic engine.

24. A round key generator for generating successive round keys of an expanded key from an initial cryptographic key for use in an encryption and/or decryption engine, comprising:
a memory for storing the Nk words of the initial key;
an expansion processor for repeatedly retrieving a selected first word and a selected second word of the expanded key, at least one of which is retrieved from the memory, and generating from the selected first and second words a successive subsequent word of the expanded key;
means for providing the generated words of the expanded key to the cryptographic engine as round keys for performing subsequent cryptographic rounds;
means for storing successive ones of the generated subsequent words in the memory by cyclically overwriting previously generated words of the expanded key.

25. The apparatus of claim 24 further including control means for ensuring previously generated words are overwritten only after those words have been used as said first and/or said second selected words by the expansion processor.

26. The apparatus of claim 24 in which the number of word locations in memory is less than the number of words in the expanded key.

27. The apparatus of claim 24 in which the number of word locations in the memory is equal to Nk.

28. The apparatus of claim 27 in which the words of the initial key are also overwritten by words of the expanded key during the overwriting.

29. The apparatus of claim 24 in which the number of word locations in the memory is equal to 2Nk.

30. The apparatus of claim 24 in which the memory is divided into two parts, a first part storing the initial key and the second part receiving the successively generated words of the expanded key.

31. The apparatus of claim 30 in which the means for storing stores the final round key in the second part of the memory and retains the initial key in the first part of the memory after completion of generation of the expanded key.

32. The apparatus of claim 31 further including means for performing a repeat key expansion starting with the initial key stored in the first part of the memory.

33. The apparatus of claim 31 further including means for performing an inverse key expansion starting with the final round key stored in the second part of the memory.

34. The apparatus of claim 24 further including means for completing generation of the expanded key such that the final round key is stored in the memory and the initial key has been overwritten.

35. The apparatus of claim 34 further including means for performing an inverse key expansion starting with the final round key stored in the memory in order to regenerate the initial key for a subsequent cryptographic operation.

36. The apparatus of claim 30 in which the number of word locations in memory is equal to 2Nk, the first and the second parts having Nk locations each.

37. The apparatus of claim 24 in which the expansion processor includes means for generating successive words of the AES Rijndael block cipher round keys according to the AES key expansion function.

38. The apparatus of claim 37 in which Nk=8.

39. The apparatus of claim 24 in which the expansion processor generates words of encryption round keys.

40. The apparatus of claim 24 in which the expansion key processor generates words of decryption round keys.

41. The apparatus of claim 24 further including a cryptographic engine, and means for providing the generated words of the expanded key to the cryptographic engine on a word-by-word basis as the cryptographic engine consumes the words as round keys.

42. The apparatus of claim 24 further including means for retrieving both the selected first word and the selected second word from the memory.

43. The apparatus of claim 24 further including means for retrieving the selected first word from memory and the selected second word from a register in the expansion processor.

44. The apparatus of claim 24 further including a cryptographic engine, in which the expansion processor and the cryptographic engine share an S-box.

45. The apparatus of claim 44 further including the means for maintaining synchronism of the expansion processor and the cryptographic engine.

46. A smart card incorporating the round key generator according to claim 24.

47. A method of generating successive round key words of an expanded key, from an initial key, which method maintains the generated successive round key words in memory substantially only as long as they are required for use in the generation of successive round key words and for use in the parallel operation of a cryptographic process.

48. The method of claim 47 in which the initial key words are also maintained in the memory during the entire process of generating the expanded key.

49. An AES round constant function generator comprising a shift register having:
a first control input for causing a left shift of the register contents;
a second control input for causing a right shift of the register contents; and
a third control input for causing a preset of the shift register contents to one of several possible values.

50. The apparatus of claim 49 in which the third control input causes a preset of the shift register contents to a value that is determined according to the current contents of the register.

51. The apparatus of claim 49 in which the several possible values are 01, 1B, 36, 80 and 40 in hexadecimal.

52. The apparatus of claim 49 in which the first control input is asserted once for each round of an AES encryption operation, and in which the second control input is asserted once for each round of an AES decryption operation.

53. (canceled)

54. (canceled)
